(19) United States
(12) Patent Application Publication
(10) Pub. No.: US 2023/0008172 A1
(43) Pub. Date: Jan. 12, 2023

(54) ELECTRIC HYDRAULIC BRAKE AND CONTROL METHOD THEREFOR

(71) Applicant: HYUNDAI MOBIS Co., Ltd., Seoul (KR)

(72) Inventors: Sung Ki AHN, Yongin-si (KR); Byoung Woo HA, Yongin-si (KR); Chun Sic YUN, Yongin-si (KR); Seung Hyun YUN, Yongin-si (KR)

(73) Assignee: HYUNDAI MOBIS Co., Ltd., Seoul (KR)

(21) Appl. No.: 17/861,468

(22) Filed: Jul. 11, 2022

(30) Foreign Application Priority Data
Jul. 12, 2021 (KR) 10-2021-0091228

(51) Int. Cl. B60T 8/94; B60T 17/22; B60T 13/68

(52) U.S. Cl. CPC B60T 8/94; B60T 17/22; B60T 13/686; B60T 2270/10; B60T 2270/20; B60T 2270/30; B60T 2270/402; B60T 13/74

(57) ABSTRACT

An electric hydraulic brake includes: wheel brakes configured to supply braking force to wheels of a vehicle; a main braking unit including a reservoir which stores brake oil, and a master cylinder configured to form pressure of the brake oil in conjunction with a main brake motor; and a hydraulic controller comprising at least one pump configured to pump the brake oil in conjunction with an auxiliary brake motor, and configured to selectively transmit the pressure of the brake oil formed in the master cylinder or the pump to the wheel brakes. The hydraulic controller includes at least one auxiliary flow path which is connected at a first end thereof to the reservoir and is connected at a second end thereof to an inlet of the pump to transmit hydraulic pressure from the reservoir to the pump directly through the at least one auxiliary flow path.

### CROSS-REFERENCE TO RELATED APPLICATIONS

This application is based on, and claims priority from, Korean Patent Application Number 10-2021-0091228, filed Jul. 12, 2021, the disclosure of which is incorporated by reference herein in its entirety.

### TECHNICAL FIELD

The present disclosure relates to an electric hydraulic brake and a control method thereof.

### BACKGROUND

The content described in this section merely provides the background information on the present disclosure and does not constitute the prior art.

An electric hydraulic brake uses an electric motor to generate hydraulic pressure and transmits the hydraulic pressure to wheel cylinders to generate braking force in each wheel cylinder. The electric hydraulic brake makes it easy to individually control the braking force generated in each wheel brake, so that a function such as an electronic stability control (ESC) system or an anti-lock brake system (ABS) can be easily implemented.

The ESC is intended to stably maintain the posture of a vehicle when the posture of the vehicle is unstable during driving. The cause of the unstable posture of the vehicle includes a road condition with a slippery road surface due to rain, snow or sand, motion inertia such as abrupt zigzag driving, etc. The ESC system controls the torque of a brake and an engine in a state where the posture of the vehicle is dangerous, thus stably maintaining the posture of the vehicle.

When a main brake system is not normally operated, an autonomous driving vehicle secures a fail-safe function using an auxiliary brake system disposed between the main brake system and the plurality of wheel brakes.

In the case where the auxiliary brake system is added to the main brake system to implement redundancy, the layout of the brake system may become complicated, and the cost and weight of the entire brake system may be increased.

### SUMMARY

According to at least one embodiment, the present disclosure provides an electric hydraulic brake including: a plurality of wheel brakes supplying braking force to wheels of a vehicle; a main braking unit including a reservoir which stores brake oil, and a master cylinder configured to form pressure of the brake oil in conjunction with a main brake motor; and a hydraulic controller including at least one pump configured to pump the brake oil in conjunction with an auxiliary brake motor, and configured to selectively transmit the pressure of the brake oil formed in the master cylinder or the pump to the plurality of wheel brakes. The hydraulic controller includes at least one auxiliary flow path which is connected at a first end thereof to the reservoir and is connected at a second end thereof to an inlet of the pump to transmit hydraulic pressure from the reservoir to the pump directly through the at least one auxiliary flow path.

According to at least one embodiment, the present disclosure provides a method of controlling an electric hydraulic brake including a main braking unit which forms pressure of brake oil using a master cylinder, and a hydraulic controller which is operated when the main braking unit malfunctions and is provided with at least one auxiliary flow path to transmit hydraulic pressure from a reservoir to a pump directly through the at least one auxiliary flow path, the method including: a transmission step of transmitting a brake signal to a first controller and a second controller, when the brake signal is generated; a determination step of determining whether a main braking unit is normally operated according to the brake signal; a main brake step of forming braking force in a plurality of wheel brakes by operating the main braking unit, when it is determined that the main braking unit is normally operated; and an auxiliary brake step of forming braking force in the plurality of wheel brakes by controlling the hydraulic controller, when it is determined that the main braking unit is not normally operated.

### BRIEF DESCRIPTION OF THE DRAWINGS

FIG. 1 is a hydraulic circuit diagram of an electric hydraulic brake according to an embodiment of the present disclosure.

FIG. 2 is a flowchart illustrating a method of controlling an electric hydraulic brake according to an embodiment of the present disclosure.

FIG. 3 is a hydraulic circuit diagram illustrating a direction in which brake oil flows when a main braking unit is normally operated in a braking process of an electric hydraulic brake according to an embodiment of the present disclosure.

FIG. 4 is a hydraulic circuit diagram illustrating a direction in which brake oil flows when a main braking unit is abnormally operated in a braking process of an electric hydraulic brake according to an embodiment of the present disclosure.

FIG. 5 is a hydraulic circuit diagram illustrating a direction in which brake oil flows when a main braking unit is normally operated in a depressurization process of an electric hydraulic brake according to an embodiment of the present disclosure.

FIG. 6 is a hydraulic circuit diagram illustrating a direction in which brake oil flows when a main braking unit is abnormally operated in a depressurization process of an electric hydraulic brake according to an embodiment of the present disclosure.

FIG. is a hydraulic circuit diagram illustrating a direction in which brake oil flows when a main braking unit and a hydraulic controller are abnormally operated in a braking process of an electric hydraulic brake according to an embodiment of the present disclosure.

### DETAILED DESCRIPTION

In view of the above, the present disclosure provides an electric hydraulic brake, in which a main braking unit and a hydraulic controller are formed in a one-box, thus enhancing the cost competitiveness of the electric hydraulic brake and securing required performance.

The problems to be solved by the present disclosure are not limited to the above-mentioned problems, and other problems which are not mentioned will be clearly understood by those skilled in the art from the following description.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, alphanumeric codes such as first, second, i), ii), (a), (b), etc., in numbering components are used solely for the purpose of differentiating one component from the other but not to imply or suggest the substances, the order, or sequence of the components. Throughout this specification, when parts “include” or “comprise” a component, they are meant to further include other components, not excluding thereof unless there is a particular description contrary thereto. The terms such as ‘unit’, ‘module’, and the like refer to one or more units for processing at least one function or operation, which may be implemented by hardware, software, or a combination thereof.

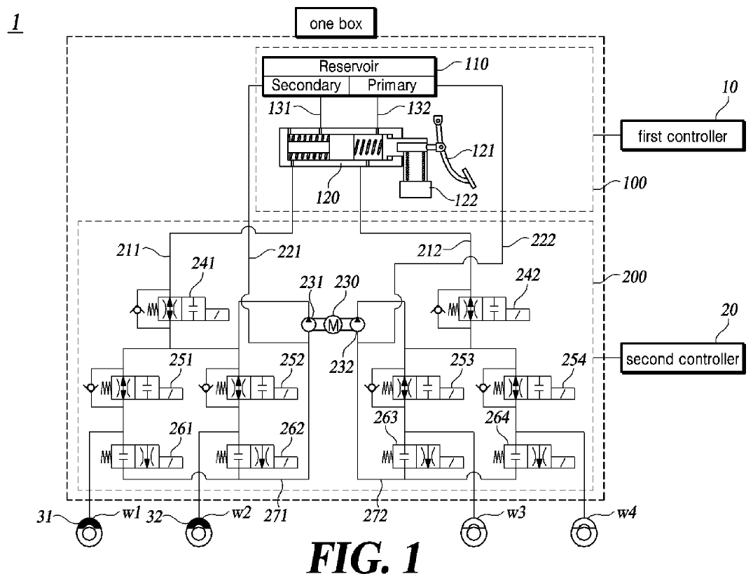

FIG. 1 is a hydraulic circuit diagram of an electric hydraulic brake according to an embodiment of the present disclosure.

Referring to FIG. 1, an electric hydraulic brake 1 according to an embodiment of the present disclosure may include all or some of a plurality of wheel brakes w1, w2, w3, and w4 which supply braking force to wheels of a vehicle, a main braking unit 100, a hydraulic controller 200, a first controller 10, and a second controller 20.

The main braking unit 100 may include a main brake motor 122, a master cylinder 120 configured to change the pressure of brake oil in conjunction with the main brake motor 122, a reservoir 110 storing the brake oil, and a plurality of supply flow paths 131 and 132 supplying the brake oil from the reservoir 110 to the master cylinder 120. In an embodiment of the present disclosure, the main brake motor 122 may be an electric booster.

The hydraulic controller 200 may include an auxiliary brake motor 230, a plurality of pumps 231 and 232 configured to change the pressure of the brake oil in conjunction with the auxiliary brake motor 230, one or more main flow paths 211 and 212 configured to transmit the hydraulic pressure of the brake oil from the master cylinder 120 to the plurality of wheel brakes w1, w2, w3, and w4, one or more auxiliary flow paths 221 and 222 directly connecting the reservoir 110 and the pumps 231 and 232 to transmit the brake oil, and one or more valves configured to selectively transmit the pressure of the brake oil formed in the master cylinder 120 or the pumps 231 and 232 to the plurality of wheel brakes w1, w2, w3, and w4.

In an embodiment of the present disclosure, a housing of the main braking unit 100 and a housing of the hydraulic controller 200 may not be coupled by a brake pipe but may be directly physically coupled to each other. In another embodiment, the hydraulic circuit and the components of the main braking unit 100 and the hydraulic controller 200 may be contained in one housing to form the one-box. Since the electric hydraulic brake is configured in the shape of the one-box, the number of valves may be reduced, and an accumulator and a check valve may be eliminated, thus saving cost. Further, the brake piping layout can be simplified.

The first controller 10 is configured to control the main brake motor 122 according to the brake input. The second controller 20 is configured to control the auxiliary brake motor 230 according to the brake input. The first controller 10 and the second controller 20 may be configured to send an electrical signal to an Electronic Parking Brake (EPB). However, the present disclosure is not limited to such a configuration. For example, the first controller 10 may be configured to control the main brake motor 122 and the auxiliary brake motor 230 according to the brake input. Herein, the brake input may be understand as an electronic signal, for example, a pedal sensing signal (PSS), which is generated based on the brake signal provided from a user's pedal input or a separate autonomous driving device.

The hydraulic controller 200 is in fluid communication with the reservoir 110, the master cylinder 120, the pumps 231 and 232, the plurality of wheel brakes w1, w2, w3, and w4, and responds to the signal of the first controller or the second controller. The hydraulic controller 200 is configured to change an internal flow path, namely, a path on which the hydraulic pressure acts or along which the brake oil flows between the reservoir 110, the master cylinder 120, the pumps 231 and 232, and the plurality of wheel brakes w1, w2, w3, and w4.

The plurality of wheel brakes w1, w2, w3, and w4 are configured to apply the braking force to the wheels of the vehicle using the hydraulic pressure. Each of the wheel brakes w1, w2, w3, and w4 may be a caliper brake. The plurality of wheel brakes w1, w2, w3, and w4 may be selectively in fluid communication with at least one of the reservoir 110, the master cylinder 120, and the pumps 231 and 232 using the hydraulic controller 200. For example, the hydraulic pressure generated in the master cylinder 120 or the pumps 231 and 232 may be applied to the plurality of wheel brakes w1, w2, w3, and w4 using the hydraulic controller 200. The plurality of wheel brakes w1, w2, w3, and w4 may apply the braking force corresponding to the hydraulic pressure to the wheels of the vehicle.

The master cylinder 120 is configured to change the pressure of the brake oil in response to the signal of the first controller 10. The master cylinder 120 has a hollow structure therein. The master cylinder 120 includes a piston disposed therein, and two hydraulic chambers partitioned by the piston. The piston is configured to move to one side as the main brake motor 122 is rotated, that is, to reciprocate and translate between the hydraulic chambers. When the main brake motor is moved clockwise or counterclockwise in response to the signal of the first controller 10, the piston may move to one side or the other side to press the brake oil filled in the two hydraulic chambers.

The pumps 231 and 232 are configured to change the pressure of the brake oil in response to the signal of the second controller 20. The pumps 231 and 232 may have the structure of an oil pump. For example, the pumps may be configured to pump the brake oil in conjunction with the rotation of the auxiliary brake motor 230 as the auxiliary brake motor 230 is operated in response to the signal of the second controller 20. The flow path of the brake oil passing through the pumps 231 and 232 may lead to the plurality of wheel brakes w1, w2, w3, and w4 using the hydraulic controller 200.

The hydraulic controller 200 of the electric hydraulic brake 1 according to an embodiment of the present disclosure includes all or some of a plurality of traction control valves 241 and 242, a plurality of inlet valves 251 to 254, and a plurality of outlet valves 261 to 264, which are related to the operation of the master cylinder 120 and the pumps 231 and 232. The traction control valves 241 and 242 and the inlet valves 251 to 254 may be a normal open type solenoid valve, while the outlet valves 261 to 264 may be a normal close type solenoid valve.

The hydraulic controller 200 includes four pairs of inlet valves 251 to 254 and outlet valves 261 to 264 disposed on the brake flow path through which the brake oil is directly supplied to or discharged from each of the wheel brakes w1, w2, w3, and w4. Further, the hydraulic controller 200 includes the first traction control valve 241 and the second traction control valve 242 for distributing the hydraulic pressure generated from the master cylinder 120 onto each brake flow path. The traction control valves 241 and 242 are configured to open or close the main flow paths 211 and 212 between the master cylinder 120 and the plurality of wheel brakes w1, w2, w3, and w4, and to regulate hydraulic pressure transmitted to the plurality of wheel brakes w1, w2, w3, and w4.

The plurality of valves are configured to independently control the braking force of the plurality of wheel brakes w1, w2, w3, and w4, respectively. For example, the valves are configured to implement the functions of the ABS (Anti-lock Brake System), TCS (Traction Control system), and ESC (Electronic Stability Control).

The hydraulic controller 200 of the electric hydraulic brake 1 according to an embodiment of the present disclosure includes a plurality of auxiliary flow paths 221 and 222 which directly guide the brake oil supplied from the reservoir 110 to the pumps 231 and 232 without passing through the master cylinder 120. The hydraulic controller 200 may include a plurality of return flow paths 271 and 272 which directly guide the brake oil to the reservoir 110 without passing through the master cylinder 120 when the electric hydraulic brake 1 is depressurized.

When the master cylinder 120 or the first controller 10 malfunctions, the auxiliary brake motor 230 of the pumps 231 and 232 is operated in response to the signal of the second controller 20. The pumps 231 and 232 operated in conjunction with the auxiliary brake motor 230 transmit the brake oil from the reservoir 110 to the plurality of wheel brakes w1, w2, w3, and w4 using the auxiliary flow paths 221 and 222. The brake oil is transmitted to the plurality of wheel brakes w1, w2, w3, and w4, so that effective auxiliary braking may be achieved by electronic control in an auxiliary braking situation.

Further, when the master cylinder 120 or the first controller 10 malfunctions in a situation where a brake pedal is released, the outlet valves 261 to 264 are controlled in response to the signal of the second controller 20, and the brake oil is transmitted to the reservoir 110 using the return flow paths 271 and 272 without passing through the master cylinder 120.

In consideration of the possibility that a device performing the function of the electric hydraulic brake may malfunction, the possibility that a problem occurs due to the malfunction of the electric hydraulic brake may be eliminated by further including an additional device having a similar function. In other words, a brake device in which redundancy is ensured can be realized. For example, even if the malfunction of the main braking unit occurs in a situation where a driver's driving is excluded or driving attention is reduced, such as smart cruise control or autonomous driving, it is possible to appropriately provide auxiliary braking force.

The electric hydraulic brake according to an embodiment of the present disclosure may further include Electronic Parking Brakes (EPB) 31 and 32 mounted on one or more wheels. In an embodiment of the present disclosure, the electronic parking brakes 31 and 32 are exemplified as being integrally mounted on the two wheel brakes w1 and w2 of the rear wheels. The two electronic parking brakes 31 and 32 may be configured to be controlled by the electrical signals of the first controller 10 and the second controller 20.

For example, when the main braking unit 100 malfunctions, the hydraulic controller 200 and the EPBs 31 and 32 perform braking. When the hydraulic controller 200 malfunctions, the main braking unit 100 and the EPBs 31 and 32 perform braking. When the EPBs 31 and 32 malfunction, the main braking unit 100, the hydraulic controller 200, and the EPBs 31 and 32 may be hydraulically and electrically configured such that the main braking unit 100 and the hydraulic controller 200 may perform a redundancy function.

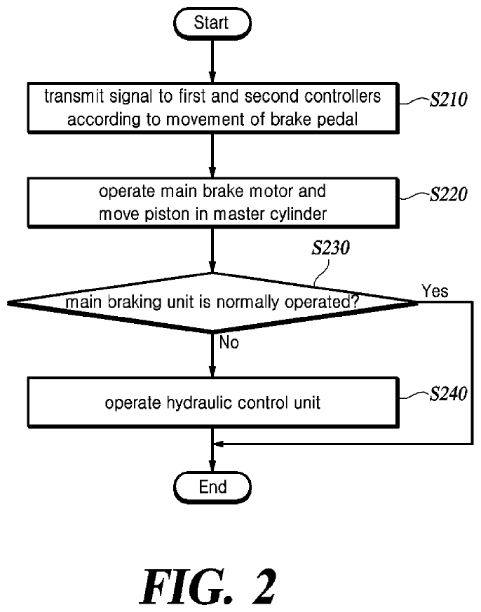

FIG. 2 is a flowchart illustrating a method of controlling an electric hydraulic brake according to an embodiment of the present disclosure.

Referring to FIG. 2, the electric hydraulic brake 1 according to an embodiment of the present disclosure transmits a signal to the first controller 10 and the second controller 20 according to the movement of the brake pedal 121 (S210).

The first controller 10 senses the moving distance and speed of the brake pedal 121 using a pedal stroke sensor or the like, and operates the main brake motor 122 based on the sensed moving distance and speed to move a piston in the master cylinder 120 forwards and backwards (S220).

The first controller 10 or the second controller 20 determines whether the main braking unit 100 is normally operated (S230). When the main braking unit 100 is normally operated, the brake oil depressurizes or pressurizes the wheel brakes w1, w2, w3, and w4 according to the movement of the piston in the master cylinder 120.

When the main braking unit 100 is not operated normally, the first controller 10 or the second controller 20 operates the auxiliary brake motor 230 or controls the outlet valves 261 to 264 to aid in controlling the main braking unit 100 (S240). When the main braking unit 100 is normally operated or a separate hydraulic controller 200 is operated to aid in controlling the main braking unit 100, this algorithm is terminated. The control method according to the pressurization or depressurization situation will be described in detail below.

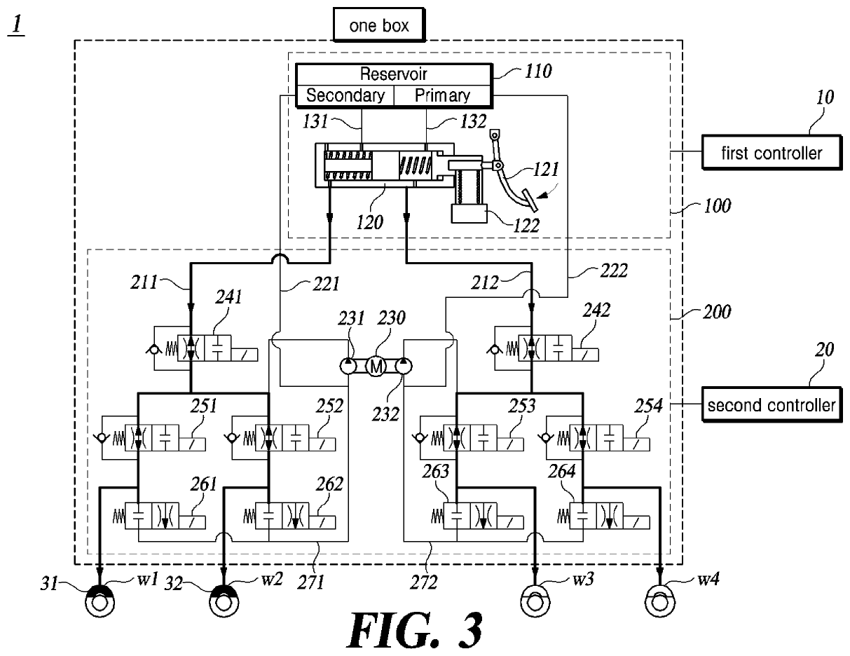

FIG. 3 is a hydraulic circuit diagram illustrating a direction in which brake oil flows when a main braking unit is normally operated in a braking process of an electric hydraulic brake according to an embodiment of the present disclosure.

Referring to FIG. 3, when a driver steps on the brake pedal 121, the main brake motor 122 is operated in proportion to the moving distance and speed of the brake pedal 121. If the main brake motor 122 is operated, the piston in the master cylinder 120 moves forwards (to the left of FIG. 3). As the piston moves forwards, the brake oil in the master cylinder 120 is pressurized and then transmitted along the main flow paths 211 and 222 to the wheel brakes w1, w2, w3, and w4 to generate braking force.

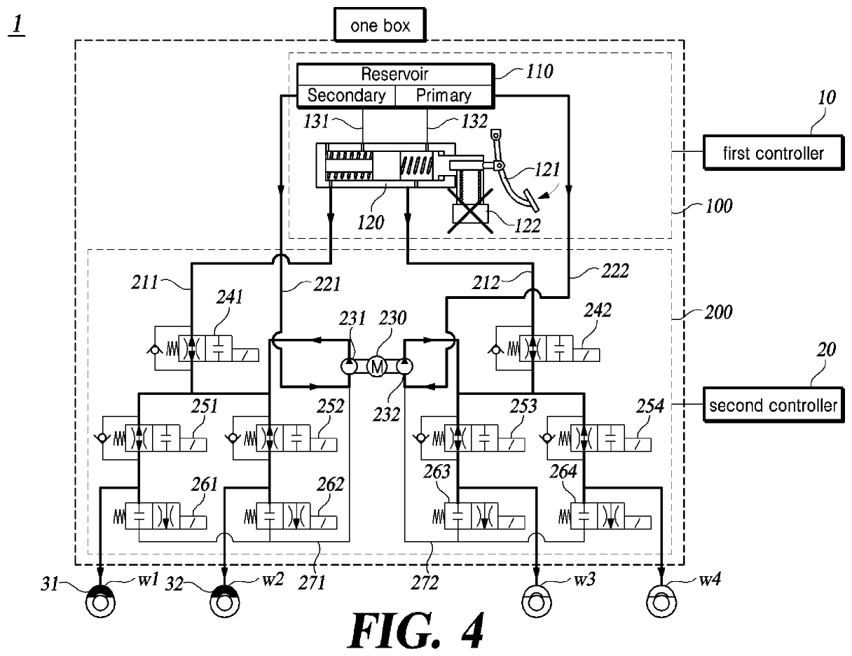

FIG. 4 is a hydraulic circuit diagram illustrating a direction in which brake oil flows when a main braking unit is abnormally operated in a braking process of an electric hydraulic brake according to an embodiment of the present disclosure.

Referring to FIG. 4, when the main braking unit 100 is abnormally operated, so that the delivered brake oil is insufficient compared to a required amount, the auxiliary brake motor 230 is operated to supplement insufficient brake oil. The auxiliary brake motor 230 directly sucks the brake oil from the reservoir 110 without passing through the master cylinder 120 using the pumps 231 and 232, and delivers the brake oil to the wheel brakes w1, w2, w3, and w4. The brake oil is transmitted by the pumps 231 and 232 along the auxiliary flow paths 221 and 222 to the wheel brakes w1, w2, w3, and w4, and generates braking force. At this time, the hydraulic pressure generated by the brake oil delivered from the master cylinder 120 and the brake oil delivered directly from the reservoir 110 by the pumps 231 and 232 may be regulated using the traction control valves 241 and 242.

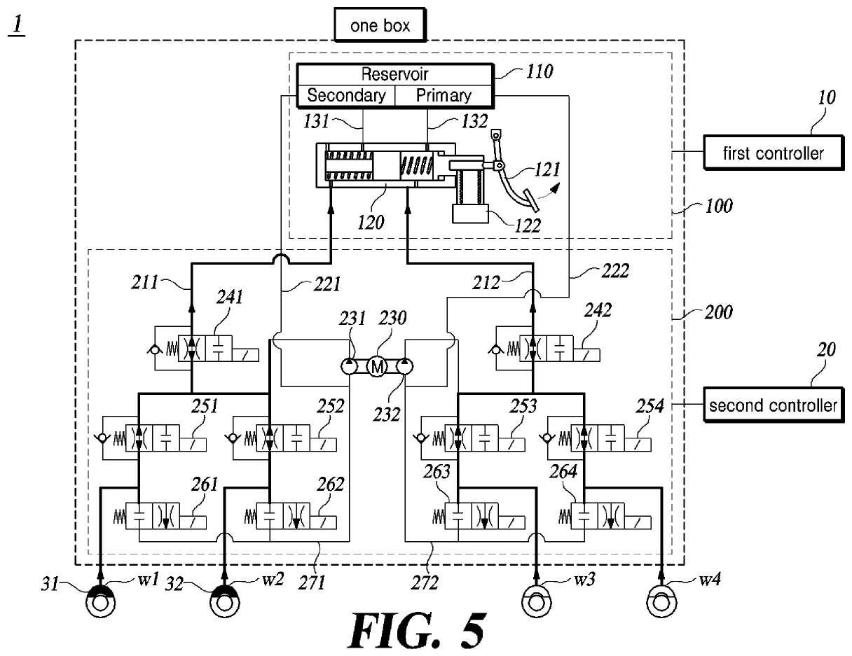

FIG. 5 is a hydraulic circuit diagram illustrating a direction in which brake oil flows when a main braking unit is normally operated in a depressurization process of an electric hydraulic brake according to an embodiment of the present disclosure.

Referring to FIG. 5, when a driver releases the brake pedal 121, the main brake motor 122 is operated in proportion to the moving distance and speed of the brake pedal 121. If the main brake motor 122 is operated, the piston in the master cylinder 120 moves backwards (to the right of FIG. 5). As the piston moves backwards, the brake oil on the wheel brakes w1, w2, w3, and w4 flows along the main flow paths 211 and 222 through the master cylinder 120 to return to the reservoir 110, and the pressure of the wheel brakes w1, w2, w3, and w4 is released.

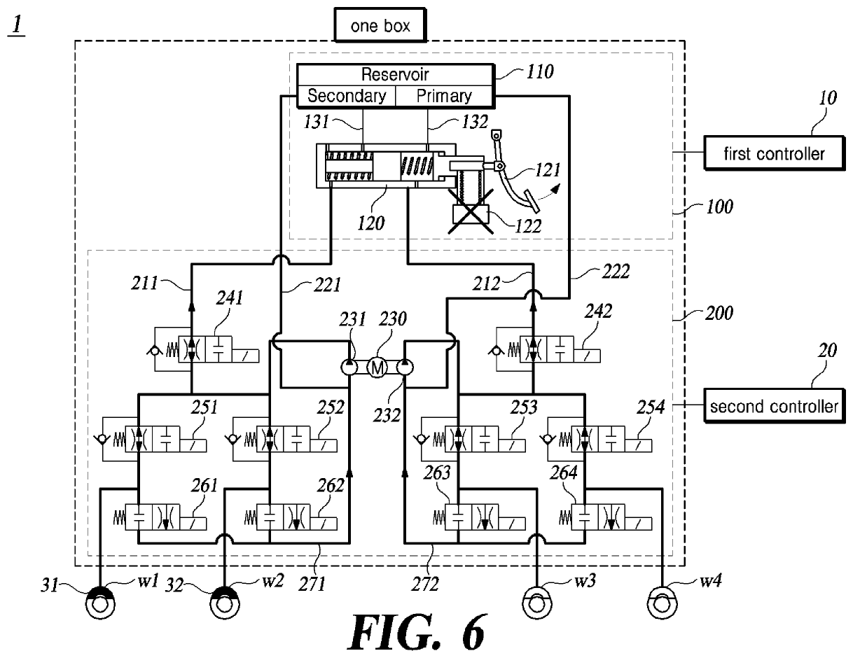

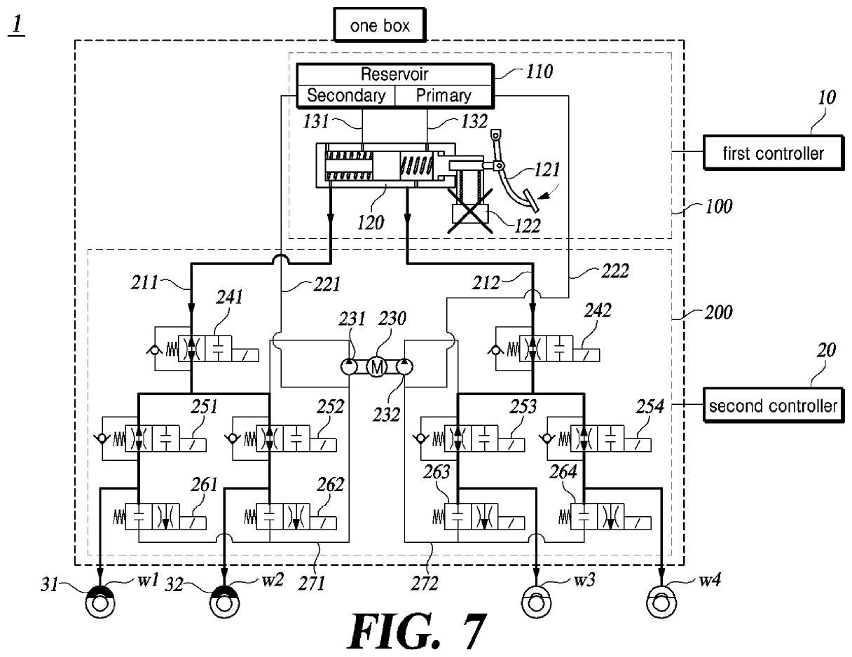

FIG. 6 is a hydraulic circuit diagram illustrating a direction in which brake oil flows when a main braking unit is abnormally operated in a depressurization process of an electric hydraulic brake according to an embodiment of the present disclosure.

Referring to FIG. 6, when the main braking unit 100 is abnormally operated, so that depressurization speed is insufficient, the first controller 10 or the second controller 20 controls the outlet valves 261 to 264. As the outlet valves 261 to 264 are opened, brake oil is transmitted along the return flow paths 271 and 272 to the reservoir 110 without passing through the master cylinder. The brake oil on the wheel brakes w1, w2, w3, and w4 is transmitted to the reservoir 110 by the main flow paths 211 and 212 and the return flow paths 271 and 272, and the pressure of the wheel brakes w1, w2, w3, and w4 is released.

FIG. 7 is a hydraulic circuit diagram illustrating a direction in which brake oil flows when a main braking unit and a hydraulic controller are abnormally operated in a braking process of an electric hydraulic brake according to an embodiment of the present disclosure.

Referring to FIG. 7, when both the main braking unit 100 and the hydraulic controller 200 are abnormally operated, the piston is moved forwards (to the left of FIG. 7) only by pedal effort. As the piston moves forwards, the brake oil in the master cylinder 120 is pressurized, so that the brake oil is transmitted along the main flow paths 211 and 222 to the wheel brakes w1, w2, w3, and w4 and generates braking force.

According to an embodiment, an electric hydraulic brake is advantageous in that a brake system is formed in a one-box, thus simplifying a brake piping layout, reducing the number of components, and thereby reducing cost.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An electric hydraulic brake comprising:
a plurality of wheel brakes configured to supply braking force to wheels of a vehicle;
a main braking unit comprising a reservoir which stores brake oil, and a master cylinder configured to form pressure of the brake oil in conjunction with a main brake motor; and
a hydraulic controller comprising at least one pump configured to pump the brake oil in conjunction with an auxiliary brake motor, and configured to selectively transmit the pressure of the brake oil formed in the master cylinder or the pump to the plurality of wheel brakes,
wherein the hydraulic controller comprises at least one auxiliary flow path which is connected at a first end thereof to the reservoir and is connected at a second end thereof to an inlet of the pump to transmit hydraulic pressure from the reservoir to the pump directly through the at least one auxiliary flow path.

2. The electric hydraulic brake of claim 1, wherein the hydraulic controller further comprises:
at least one main flow path transmitting hydraulic pressure formed in the master cylinder.

3. The electric hydraulic brake of claim 2, wherein the hydraulic controller further comprises:
at least one traction control valve configured to open or close the main flow path, and control the pressure of the brake oil delivered from the master cylinder.

4. The electric hydraulic brake of claim 1, wherein the hydraulic controller further comprises:
at least one inlet valve and at least one outlet valve for controlling the pressure of the brake oil delivered from the master cylinder or the pump.

5. The electric hydraulic brake of claim 4, wherein the hydraulic controller further comprises:
at least one return flow path connected at a first end thereof to the auxiliary flow path, and connected at a second end thereof to the outlet valve.

6. The electric hydraulic brake of claim 1, further comprising:
at least one supply flow path connecting the reservoir and the master cylinder.

7. The electric hydraulic brake of claim 1, further comprising:
a first controller configured to control the main brake motor according to brake input; and
a second controller configured to control the auxiliary brake motor according to brake input when the first controller or the main braking unit malfunctions, and configured to control the pump so as to transmit the pressure of the brake oil formed in the pump to the plurality of wheel brakes.

8. The electric hydraulic brake of claim 7, wherein the first controller is configured to control the auxiliary brake motor according to the brake input.

9. The electric hydraulic brake of claim 7, further comprising:
an Electronic Parking Brake (EPB),
wherein the first controller is configured to send an electrical signal to the EPB, when the main braking unit or the first controller malfunctions.

10. The electric hydraulic brake of claim 7, further comprising:
an Electronic Parking Brake (EPB),
wherein the second controller is configured to send an electrical signal to the EPB, when the hydraulic controller or the second controller malfunctions.

11. A method of controlling an electric hydraulic brake comprising a main braking unit which forms pressure of brake oil using a master cylinder, and a hydraulic controller which is operated when the main braking unit malfunctions and is provided with at least one auxiliary flow path to transmit hydraulic pressure from a reservoir to a pump directly through the at least one auxiliary flow path, the method comprising:
a transmission step of transmitting a brake signal to a first controller and a second controller, when the brake signal is generated;
a determination step of determining whether a main braking unit is normally operated according to the brake signal;
a main brake step of forming braking force in a plurality of wheel brakes by operating the main braking unit, when it is determined that the main braking unit is normally operated; and
an auxiliary brake step of forming braking force in the plurality of wheel brakes by controlling the hydraulic controller, when it is determined that the main braking unit is not normally operated.
